(19) United States
(12) Patent Application Publication
(10) Pub. No.: US 2007/0085357 A1
(43) Pub. Date: Apr. 19, 2007

(54) General purpose scooper with disposable collector

(76) Inventor: Vahid Vafaei, Newcastle, WA (US)

Correspondence Address: Vahid Vafaei, 8033 148th Ave SE, Newcastle, WA, 98059, US

(21) Appl. No.: 11/499,347

(22) Filed: Aug. 3, 2006

Related U.S. Application Data
(60) Provisional application No. 60/726,867, filed on Oct. 14, 2005.

(51) Int. Cl. A01K 29/00

(52) U.S. Cl. 294/1.4

(57) ABSTRACT

A scooper and methods for collecting pet excrement are provided. In some embodiments, a scooper includes a handle, and a disposable collector attached removably to the handle. The collector includes a preassembled combination of a bag and a frame that holds the bag open. Therefore, the handle does not need to be cleaned, because it is only the disposable collector that has contacted the pet excrement.

### PRIORITY CLAIM

This application claims priority to U.S. Provisional Application 60/726,867 filed Oct. 14, 2005. The foregoing application is hereby incorporated by reference in its entirety as if fully set forth herein.

### FIELD OF THE INVENTION

This invention relates generally to scoopers, and more specifically, to systems and methods for scooping pet excrement.

### BACKGROUND OF THE INVENTION

Mankind has been domesticating animals for thousands of years, and the first domesticated animal was likely the dog, which is estimated to have been domesticated as early as 15,000 BC. Currently, domesticated pets, such as dogs and cats are very popular and these animals are owned by people in both urban and rural areas. Many pet owners must frequently take their pets on walks, which among other things, allows the pet and its owner to get exercise. Additionally, because many pets are kept in a house for long periods of time, the walk is a time when the pet can defecate and urinate freely without creating a mess in the house.

In many areas, social courtesy and sometimes the law requires pet owners to clean up the excrement of their pets. Picking up excrement, however, is disgusting to the majority of pet owners. The smell and texture of pet excrement can make its clean-up revolting. Additionally, pets will frequently defecate in the house or other domestic areas, which is equally if not more disgusting for pet owners to clean-up. Accordingly, there is a need for systems or methods that allow for a more pleasant and sanitary clean-up of pet excrement.

Commonly, pet owners will cover their hand with a common plastic bag, grasp the pet excrement, and then fold the bag around the excrement for later disposal. Although this method is often sanitary, any hole or tear in the plastic bag will allow the pet owner to come in contact with excrement. Additionally, even when this method is used and is sanitary, it is still disgusting because the pet user can still feel the excrement through the plastic bag, which is quite disturbing to most people. Accordingly, this is not a suitable method of managing pet excrement.

Additional methods of scooping or catching pet excrement do exist in the art. They include U.S. Pat. Nos. 3,786,780, 3,810,670, 4,236,741, 4,349,224, 4,641,873, 4,705,310, 4,718,707, 5,320,393, 5,540,470, 5,671,959, 5,820,179, 6,485,073, 6,641,188 and 6,736,436. Problems, however, include that some of these devices commonly allow the pet excrement to come in contact with an integral part of the device, which creates a need to thoroughly clean the device after each use and creates the possibility that excrement will remain on the device after use, which would be unsanitary and make the device smelly. Another problem is with devices that allow a user to position a catching means under a pet while it defecates; however, these devices suffer from similar drawbacks as described above and can be unpleasant because the device's use requires the user to watch the pet defecate. Moreover, positioning such a device behind a pet can be alarming to a pet. Therefore, what are needed are better systems and methods for scooping pet excrement.

### SUMMARY OF THE INVENTION

This invention relates generally to scoopers, and more specifically, to systems and methods for scooping pet excrement.

In some embodiments, a scooper for collecting pet excrement includes a handle, and a disposable collector for receiving the excrement, which is attached removably to the handle. The collector includes a combination of a preassembled bag, and a frame that can hold the bag open. This way the user does not have to assemble the bag with the frame.

An advantage of the invention is that only the disposable collector has contacted the pet excrement. Therefore, the handle does not need to be cleaned. As such, disposing the whole collector is both sanitary and convenient.

These and other features and advantages of the invention will be better understood in view of the detailed description and the drawings, in which:

### BRIEF DESCRIPTION OF THE DRAWINGS

Embodiments of the present invention are described in detail below with reference to the following drawings:

FIG. 1 is a perspective view of a scooper, in accordance with an embodiment of the invention;

FIG. 2 is a perspective view of a scooper head, in accordance with an embodiment of the invention;

FIG. 3 is a perspective view of a scooper head, in accordance with an embodiment of the invention;

FIG. 4 is a perspective view of a scooper head, in accordance with another embodiment of the invention;

FIG. 5 is a cross section view of a collector coupling apparatus, in accordance with an embodiment of the invention;

FIG. 6 is a cross section view of a collector coupling apparatus, in accordance with a still further embodiment of the invention;

FIG. 7 is a cross section view of a collector coupling apparatus, in accordance with another embodiment of the invention;

FIG. 8 is a cross section view of a handle, in accordance with an embodiment of the invention; and

FIG. 9 is a cross elevational view of a handle, in accordance with another embodiment of the invention.

### DETAILED DESCRIPTION

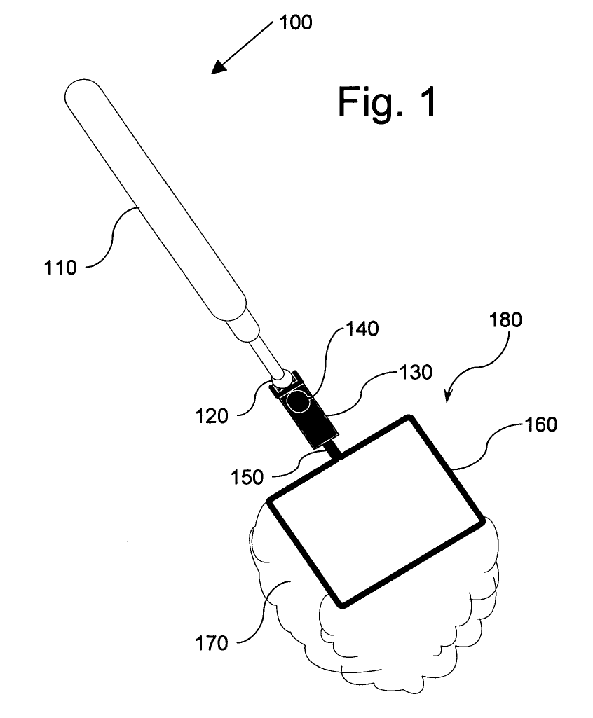

This invention relates generally to scoopers, and more specifically, to systems and methods for scooping pet excrement. Specific details of certain embodiments of the invention are set forth in the following description and in FIGS. 1-9 to provide a thorough understanding of such embodiments. The present invention may have additional embodiments, or may be practiced without one or more of the details described for any particular described embodiment.

In some embodiments, a scooper for collecting pet excrement includes a handle that has a length which is extendable. It also has a collector for receiving the excrement, while the handle is extended. The length can be extendable in any number of ways. For example, it can be extendable telescopically. Alternately, it can be extendable by unfolding handle segments that are jointed at their ends. Or it can be extendable by adding serially distinct handle segments.

According to a related method, one can walk their pet, while carrying a scooper. When needed, a length of a handle of the scooper is extended for reaching down without bending. Then the excrement is collected using the scooper, while the handle is extended. The length can then be left the same, or contracted back for carrying.

An advantage of the invention is that the scooper can be carried and stored while the length of the handle is not extended.

In other embodiments, a scooper for collecting pet excrement includes a handle, and a collector that is also known as a scooper head. The collector is attached removably to the handle. Such attachment can be performed in any number of ways, e.g. by appropriately shaping the handle. In some embodiments, a collector coupling apparatus is attached to the handle.

The collector includes a frame, and a bag having a rim that is coupled to the frame. Coupling is such that the bag is held open by the frame for receiving the pet excrement through the rim. In some embodiments, a portion or all of the rim is attached to a portion or all of the frame.

The combination of the frame and the bag can be made in a number of ways, such as in a single piece. In some such ways, they are sold as an accessory for the handle.

In some embodiments, the combination of the frame and the bag is provided preassembled. This is an improvement over U.S. Pat. No. 4,349,224, where the user has to affix the bag to the frame, only to dispose both of them afterwards.

The frame can have various shapes and sizes. For example, it can form a closed loop. Or it can have a perimeter that is substantially circular, or has at least one straight edge.

In some embodiments, the frame is rigid. In others, the frame includes at least one inflexible member and one flexible member, such as a wire, a twine, a nylon wire, etc.

Preassembling can be performed by the manufacturer in any number of ways. These depend, of course, on the particular properties of the frame that are described below, for example its shape, whether it is flexible or not, and its mechanism for coupling to the handle. In some embodiments, the rim of the bag is wrapped around at least a portion of the frame, and glued unto itself, which is economical when the bag is made of plastic. Some portion of the frame might need to be free from the bag, for coupling to the handle.

In some embodiments, the handle includes a collector coupling apparatus. In those, the collector can be attached removably to the collector coupling apparatus, such as from the frame. For example, the collector can include a plug, such as in the frame, and the collector coupling apparatus can include a slot for slidably receiving the plug.

In some embodiments, the collector coupling apparatus includes a release mechanism for releasing the collector. The release mechanism can be made in any number of ways, such as including a button for pressing, a lever for actuating, etc. In some embodiments, the collector coupling apparatus further includes an ejection mechanism. This can actually eject the collector with force, when the release mechanism is actuated. The ejection mechanism can be made in any number of ways, such as by including a spring.

The invention also includes methods. In some embodiments, one can walk a pet while carrying a scooper that has a handle and a collector. When needed, they can collect excrement of the pet in the collector. Then they can release the whole collector from the handle, such as into a trash can. Then, while preparing for another walk, another collector can be removably attached to the handle.

In some embodiments, releasing is such that the user does not have to assist by touching the collector, while removing it from the handle. This can be performed by shaking the handle, or other ways. In some embodiments, the device is shaped such that the collector is not only released, but further ejected by force.

Embodiments are now described in more detail.

FIG. 1 is a perspective view of a scooper 100, in accordance with an embodiment of the invention. FIG. 1 depicts a handle 110 that is coupled to a collector coupling apparatus 130 by a handle coupling member 120, and the collector coupling apparatus 130 is further coupled to a scooper head 180. The collector coupling apparatus 130 comprises a release button 140. The scooper head 180 comprises a frame plug 150, a frame 160, and a bag 170.

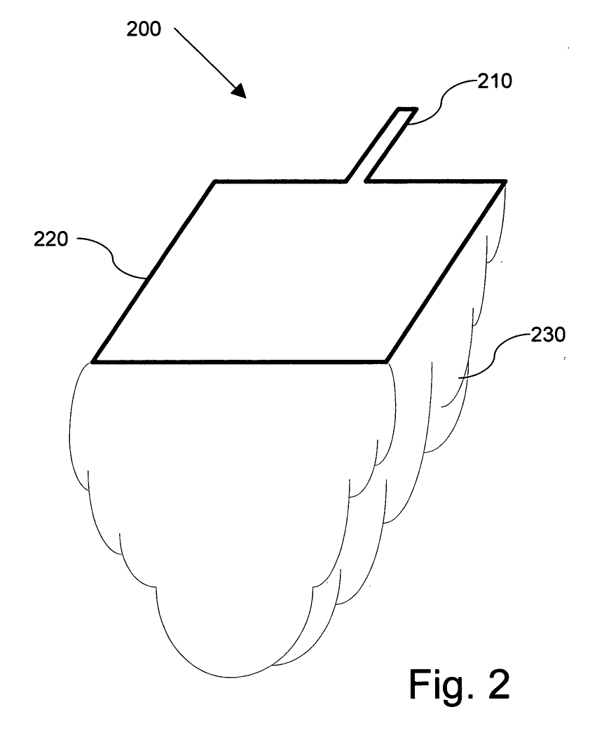

FIG. 2 is a perspective view of a scooper head 200, in accordance with an embodiment of the invention. FIG. 2 depicts a scooper head 200, which comprises a frame plug 210, a frame 220, and a bag 230. The frame 220 defines a rectangular orifice and the bag 230 is coupled to the frame 220 around the circumference of the rectangular orifice that is defined by the frame 220, which closes the bag 230 aside from the rectangular orifice.

The bag 230 can be coupled to the frame 220 in any way, including but not limited to glue, tape, or welding. The bag 230 can be made of any material including but not limited to plastic, paper, textile, or composite and can be of any shape, size or thickness. In one embodiment, the bag 230 can be coupled to the frame 220 by being wrapped around the frame 220 and then having the bag 230 coupled to itself. In another embodiment, the bag 230 is not attached to the frame 220 around the entire circumference of the frame 220.

The frame 220 can be made of any material, including, but not limited to metal, wood, plastic, paper, glass, ceramic or composite and can be any shape or diameter. In one embodiment, the frame 220 is made of metal wire. In another embodiment, the frame 220 can form any polygon or other shape, either regular or irregular, including but not limited to a circle, square, or rectangle. In a still further embodiment the frame 220 can reside in more than a two dimensional plane.

The frame plug 210 is formed by the same material as the frame 220 and defines a rectangular loop that is configurable to couple with the collector coupling apparatus 130 (not show in FIG. 2). In another embodiment, the frame plug 210 can be of any shape or size and can reside in more than a two dimensional plane. In a further embodiment, the frame plug 210 can be defined by a material that is an extension of the frame 220 or attached to the frame 220, and this material may be any material.

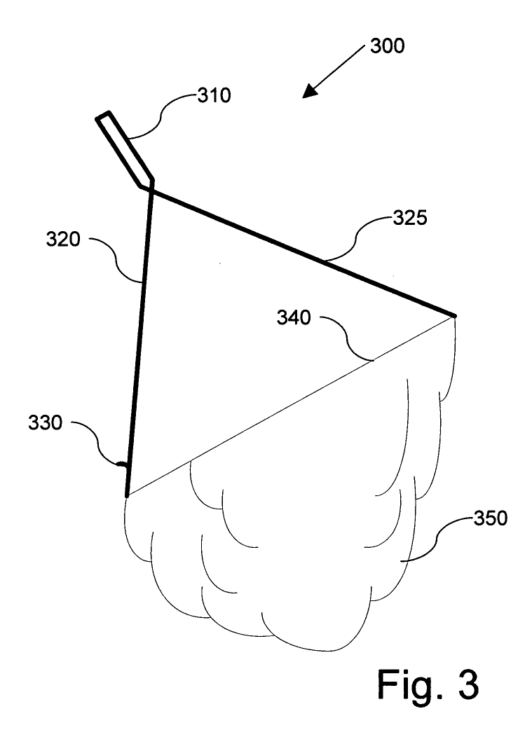

FIG. 3 is a perspective view of a scooper head 300, in accordance with an embodiment of the invention. FIG. 3 depicts a linear first and second frame member 320, 325, which are both coupled to a frame plug 310, and a hook 330 is coupled to the first frame member 320. Additionally, a bag 350 is coupled to the first and second frame member 320, 325 and the bag 350 defines a single orifice, which is defined by the first and second frame member 320, 325 and a bag lip 340, which is the edge of the bag 350.

The bag 350 can be coupled to the first and second frame member 320, 325 in any way, including but not limited to glue, tape, or welding. The bag 350 can be made of any material including but not limited to plastic, paper, textile, or composite and can be of any shape, size or thickness. In one embodiment, the bag 350 can be coupled to the first and second frame member 320, 325 by being wrapped around the first and second frame member 320, 325 and then having the bag 350 coupled to itself. In another embodiment, the bag 350 is not attached to the first and second frame member 320, 325 along the entire length of the first and second frame member 320, 325.

The first and second frame member 320, 325 can be made of any material, including, but not limited to metal, wood, plastic, paper, glass, ceramic or composite and can be any shape or diameter. In one embodiment, the first and second frame member 320, 325 is made of metal wire. In a still further embodiment the first and second frame member 320, 325 can reside in more than a two dimensional plane. In yet another embodiment, the first and second frame member 320, 325 can be curved, coiled or bent in any configuration and first and second frame member 320, 325 need not be symmetrical.

The third frame member 340 can be made of any flexible material, including, but not limited to wire, twine, nylon wire or can be an extension of the lip of the bag 350.

The frame plug 310 is formed by the same material as the frame 310 and defines a loop that is configurable to couple with the collector coupling apparatus 130 (not show in FIG. 2). In another embodiment, the frame plug 310 can be of any shape or size and can reside in more than a two dimensional plane. In a further embodiment, the frame plug 310 can be defined by a material that is an extension of the frame 310 or attached to the frame 310, and this material may be any material.

In one embodiment, the orifice defined by the bag lip 340 and the first and second frame member 320, 325 can be closed or partially closed by pulling, pushing or configuring the first and second frame member 320, 325 towards each other and configuring the hook 330 to hold the first frame member 320 to the second frame member 325. In one embodiment, the hook 330 can be replaced with any means by which to couple the first and second frame member 320, 325, including, but not limited to a slot and pin, hook and loop, clasp, tape, or glue. In a still further embodiment, the first and second frame member 320, 325 can be made of a material that is flexible such that the first and second frame member 320, 325 may be pulled or pushed together. In another embodiment the first and second frame member 320, 325 can be joined at a pivot or hinge that allows the first and second frame member 320, 325 to be pushed, pulled or otherwise configured to be coupled or near each other.

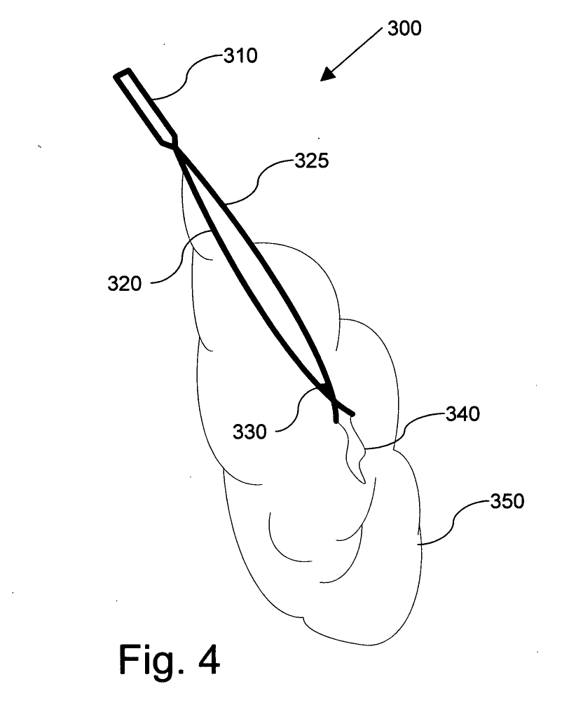

FIG. 4 depicts the scooper head 300 of one embodiment of the invention, which has been configured such that the hook 330 couples the first and second frame member 320, 325 together and thereby closes or partially closes the bag 350 orifice.

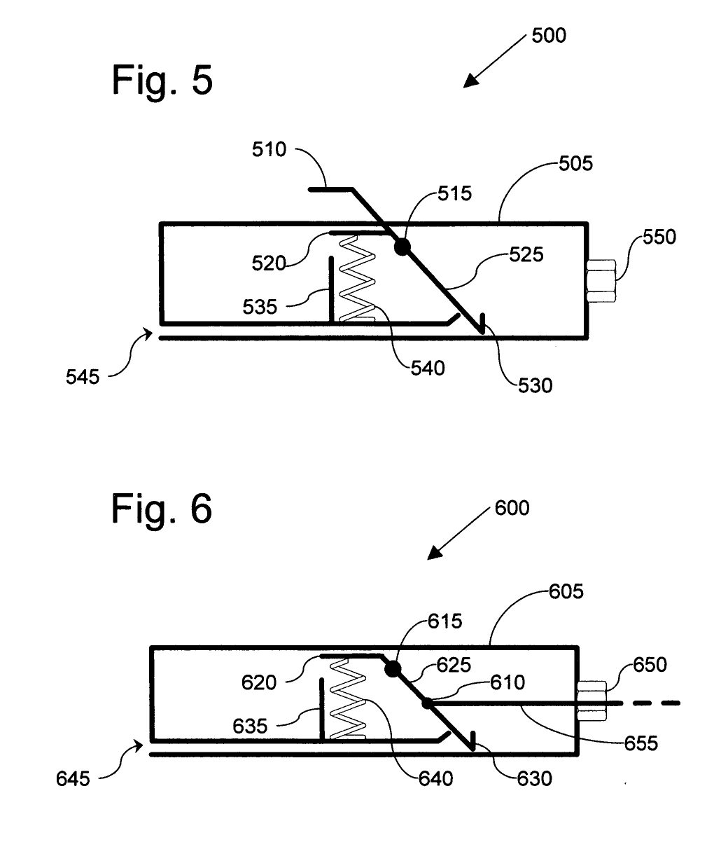

FIG. 5 is a cross section view of a collector coupling apparatus 500, in accordance with an embodiment of the invention. FIG. 5 depicts the collector coupling apparatus 500, which is defined by a housing 505. The housing 505 further defines a frame slot 545 and a handle coupling member 550 is coupled to the housing 505. Additionally, there is a latch arm 525, which comprises a release button 510, a latch hinge 515, a spring flange 520 and a latch 530. The spring flange 520 contacts a latch spring 540, which is positioned against or near a spring bar 535.

The frame slot 545, which is defined by the housing 505, is configured to accept a frame plug 210, 310 (not shown in FIG. 5) and allows the terminal end of a frame plug 210, 310 to interact with the latch 530 and latch arm 525. In one embodiment, the frame slot 545 is configured to define an orifice that is equal to or greater than the width of a frame plug 210, 310. In another embodiment, the frame slot 545 can be any size or shape, either regular or irregular.

The latch arm 525 is coupled to the housing 505 by the latch hinge 515, which allows the latch arm 525 to pivot or turn about the axis of the latch hinge 515. The latch arm 525 extends through a hole or orifice in the housing 505 and the terminal end of the latch arm 525 defines the release button 510. In one embodiment, the release button 510 can further comprise additional material on or around the end of the latch arm 510. Systems and methods of creating buttons are well known in the art and many variations of the release button 510 will be immediately apparent to one skilled in the art, and any such systems or methods may be used in additional embodiments of the invention.

To facilitate coupling of a scooper head 180, 200, 300 (not shown in FIG. 5) to the collector coupling apparatus 500, the frame plug 210, 310 (not shown in FIG. 5) of a scooper head 180, 200, 300 is inserted into to the frame slot 545. The frame plug 210, 310 and the frame slot 545 are configured to allow the frame plug 210, 310 to extend into the frame slot 545 so that the frame plug 210, 310 can interact with the latch 530 and latch arm 525. When the frame plug 210, 310 is inserted into the frame slot 545 it will initially contact the latch 530. When some force is applied to the scooper head 180, 200, 300, which forces the frame plug 210, 310 against the latch 530, the latch 530 will be forced aside and allow the frame plug 210, 310 to extend further into the frame slot 545. Forcing the latch 530 aside allows the latch arm 525 to pivot about the latch hinge 515, which thereby decreases the distance between the first end of the latch spring 540 and the second end of the latch spring 540 by putting pressure on the spring 540 and thereby compressing the spring 540 through the latch flange 520. As the latch spring 540 is compressed the spring bar 535 stabilizes the latch spring 540.

Forcing the latch 530 aside allows the frame plug 210, 310 to extend further into the frame slot 545. The frame plug 210, 310 is configured to accept the latch 530 within the loop defined by the frame plug 210, 310 and the force created by the compressed latch spring 540 is transferred to the latch 530, which will snap or move into the loop defined by the frame plug 210, 310, which will thereby couple or secure the frame plug 210, 310 and therefore the scooper head 180, 200, 300 is coupled to the collector coupling apparatus 500.

To release the scooper head 180, 200, 300 from the collector coupling apparatus 500, a user can press on the release button 510, which will rotate the latch arm 525 about the latch hinge 515, which thereby lifts the latch 530 out of the loop defined by the frame plug 210, 310 and thereby allows a user to pull the frame plug 210, 310 out of the frame slot 545 or allows gravity to pull the frame plug 201, 310 out of the frame slot 545. Removing pressure from the release button 510 allows the latch to return to a resting position, which would facilitate the frame plug 210, 310 being re-coupled to the collector coupling apparatus 500.

The collector coupling apparatus 500 can be coupled to a handle 110, 800, 900 (not shown in FIG. 5) by coupling the handle 110, 800, 900 to the collector coupling apparatus 500 via the handle coupling member 550. The handle coupling member 550 is a nut that is coupled to the collector coupling apparatus 500, which allows a complementary screw tip 860, 940 on a handle 110, 800, 900 to couple the handle 110, 800, 900 to the collector coupling apparatus 500. In another embodiment, a handle 110, 800, 900 can be an integral part of the collector coupling apparatus 500. Additionally, further systems and methods of coupling the handle 110, 800, 900 to the collector coupling apparatus 500 can be used to couple the handle 110, 800, 900 to the collector coupling apparatus 500. Such systems and methods of coupling are well know in the art and such methods or systems and variations of such systems and methods will be immediately apparent to those reasonably skilled in the art.

In one embodiment the collector coupling apparatus 500 can be any shape or size and can be made of any material, including, but not limited to plastic, metal, glass, paper, rubber or textile.

FIG. 6 is a cross section view of a collector coupling apparatus 600, in accordance with a still further embodiment of the invention. FIG. 6 depicts the collector coupling apparatus 600, which is defined by a housing 605. The housing 605 further defines a frame slot 645 and a handle coupling member 650 is coupled to the housing 605. Additionally, there is a latch arm 625, which comprises a latch hinge 615, a spring flange 620, a line coupling point 610 and a latch 630. A line 655 is attached to the latch arm 625 at the line coupling point 610 and the line 655 passes through a hole or orifice in the housing 605 and through a hole or orifice in the handle coupling member 650. The spring flange 620 contacts a latch spring 640, which is positioned against or near a spring bar 635.

To facilitate coupling of a scooper head 180, 200, 300 (not shown in FIG. 6) to the collector coupling apparatus 600, the frame plug 210, 310 (not shown in FIG. 6) of a scooper head 180, 200, 300 is inserted into to the frame slot 645. The frame plug 210, 310 and the frame slot 645 are configured to allow the frame plug 210, 310 to extend into the frame slot 645 so that the frame plug 210, 310 can interact with the latch 630 and latch arm 625. When the frame plug 210, 310 is inserted into the frame slot 645 it will initially contact the latch 630. When some force is applied to the scooper head 180, 200, 300, which forces the frame plug 210, 310 against the latch 630, the latch 630 will be forced aside and allows the frame plug 210, 310 to extend further into the frame slot 645. Forcing the latch 630 aside allows the latch arm 625 to pivot about the latch hinge 615, which decreases the distance between the first end of the latch spring 640 and the second end of the latch spring 640 by putting pressure on or compressing the spring 640 by the latch flange 620. As the latch spring 640 is compressed the spring bar 635 stabilizes the latch spring 640.

Forcing the latch 630 aside allows the frame plug 210, 310 to extend further into the frame slot 645. The frame plug 210, 310 is configured to accept the latch 630 within the loop defined by the frame plug 210, 310 and the force created by the compressed latch spring 640 is transferred to the latch 630, which will snap or move into the loop defined by the frame plug 210, 310, which will thereby couple the frame plug 210, 310 and therefore the scooper head 180, 200, 300 is coupled to the collector coupling apparatus 600.

To release the scooper head 180, 200, 300 from the collector coupling apparatus 600, a user can pull on the line 655, which will rotate the latch arm 625 about the latch hinge 615, which thereby lifts the latch 630 out of the loop defined by the frame plug 210, 310 and thereby allows a user to pull the frame plug 210, 310 out of the frame slot 645 or allows gravity to pull the frame plug 210, 310 out of the frame slot 645. Removing tension from the line 655 allows the latch 630 to return to a resting position, which would facilitate the frame plug 210, 310 being re-coupled to the collector coupling apparatus 600. The line 655, which passes through the housing 605 and the handle coupling member 650 can be configured to be held within a handle 110, 800, 900 and further configured to facilitate a user to apply tension to the line 655. Systems and methods of providing tension on a line are well known in the art and any of these systems or methods or variations thereon may be used in other embodiments of the present invention. In one embodiment the line 655 can be made of any material, including, but not limited to plastic, metal, string, rope, textile and can be any shape, size or diameter, either regular or irregular. In another embodiment, the line 655 is a metal wire.

In one embodiment the collector coupling apparatus 600 can be any shape or size and can be made of any material, including, but not limited to plastic, metal, glass, paper, rubber or textile.

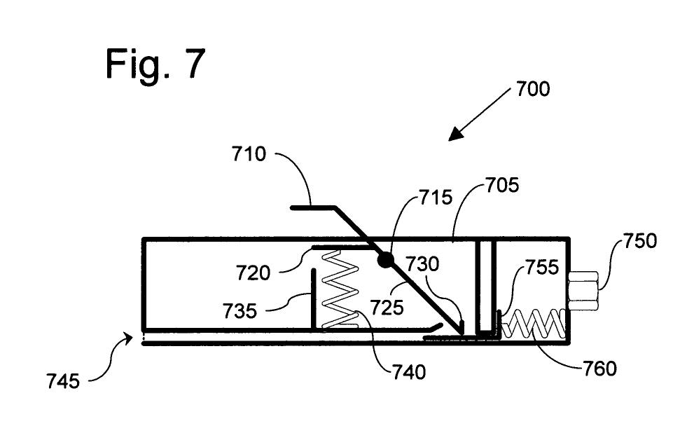

FIG. 7 is a cross section view of a collector coupling apparatus 700, in accordance with another embodiment of the invention. FIG. 7 depicts the collector coupling apparatus 700, which is defined by a housing 705. The housing 705 further defines a frame slot 745 and a handle coupling member 750 is coupled to the housing 705. Additionally, there is a latch arm 725, which comprises a latch hinge 715, a spring flange 720, a release button 710 and a latch 730. The spring flange 720 contacts a latch spring 740, which is positioned against or near a spring bar 735. Moreover, there is an ejection plate 755, which is positioned near or against an ejection spring 760.

To facilitate coupling of a scooper head 180, 200, 300 (not shown in FIG. 7) to the collector coupling apparatus 700, the frame plug 210, 310 (not shown in FIG. 7) of a scooper head 180, 200, 300 is inserted into to the frame slot 745. The frame plug 210, 310 and the frame slot 745 are configured to allow the frame plug 210, 310 to extend into the frame slot 745 so that the frame plug 210, 310 can interact with the ejection plate 755. When the frame plug 210, 310 is inserted into the frame slot 745 it will initially contact the ejection plate 755. When force is applied to the scooper head 180, 200, 300, which forces the frame plug 210, 310 against the ejection plate 755, the ejection plate 755 will be forced against the ejection spring 760, thereby compressing the ejection spring 760 and thereby allowing the frame plug 210, 310 to extend further into the frame slot 745. Forcing the ejection plate 755 against the ejection spring 760 allows the frame plug 210, 310 to extend further into the frame slot 745. The frame plug 210, 310 is configured to accept the latch 730 within the loop defined by the frame plug 210, 310 and the force created by the compressed latch spring 740, which is present in the resting state of the latch arm 725, is transferred to the latch 730, which will snap or move into the loop defined by the frame plug 210, 310, which will thereby couple or secure the frame plug 210, 310 and the scooper head 180, 200, 300 is thereby coupled to the collector coupling apparatus 700.

To release the scooper head 180, 200, 300 from the collector coupling apparatus 700, a user can press on the release button 710, which will rotate the latch arm 725 about the latch hinge 715, which thereby lifts the latch 730 out of the loop defined by the frame plug 210, 310 and thereby allows the force created by the compressed ejection spring to force the ejection plate 755 into against the frame plug 210, 310, which ejects the frame plug 210, 310 out of the frame slot 745, assisting gravity in ejecting the frame plug 210, 310 or facilitates easy removal of the frame plug 210, 310 Removing pressure from the release button 710 allows the latch to return to a resting position, which would facilitate the frame plug 210, 310 being re-coupled to the collector coupling apparatus 700. In another embodiment, the collector coupling apparatus 700 can comprise a line or a line coupling point.

In one embodiment the collector coupling apparatus 700 can be any shape or size and can be made of any material, including, but not limited to plastic, metal, glass, paper, rubber or textile.

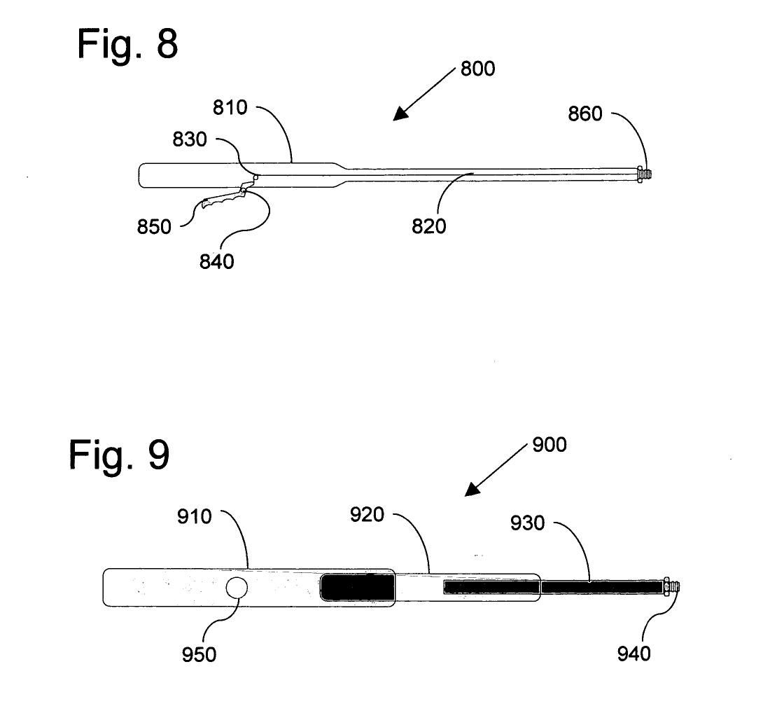

FIG. 8 is a cross section view of a handle 800, in accordance with an embodiment of the invention. FIG. 8 depicts a handle body 810, to which a screw tip 860 is attached at a distal end of the handle body 810. A line 820 is present inside the handle body 810, passes over a line bar 830, and is attached to a lever 850, which comprises a lever hinge 840. To apply tension to the line, a user depresses the lever 850, which pivots about the lever hinge 840 and thereby applies tension to the line 820, which passes over the line bar 830. To couple the handle 800 to a collector coupling apparatus 500, 600, 700 (not shown in FIG. 8) is achieved by screwing the screw tip 860 into a handle coupling member 550, 650, 750 (not shown in FIG. 8). In another embodiment the handle 800 may be of any shape or size and may be made of any material. In one embodiment, the handle body 810 can be telescoping. In a still further embodiment, the handle 800 may be coupled to a collector coupling apparatus 500, 600, 700 by any means known or unknown in the art. Systems and methods of providing tension on a line are well known in the art and any of these systems or methods or variations thereof may be used in other embodiments of the present invention.

FIG. 9 is an elevation view of a handle 900, in accordance with another embodiment of the invention. FIG. 9 depicts a telescoping handle 900, which comprises a first, second, and third handle segment 910, 920, 930, a screw tip 940, and a release button. To couple the handle 900 to a collector coupling apparatus 500, 600, 700 (not shown in FIG. 9) is achieved by screwing the screw tip 960 into a handle coupling member 550, 650, 750 (not shown in FIG. 9) In another embodiment the handle 900 may be of any shape or size and may be made of any material. In a still further embodiment, the handle 900 may be coupled to a collector coupling apparatus 500, 600, 700 by any means known or unknown in the art. To remove or eject a scooper head 180, 200, 300 from a collector coupling apparatus 500, 600, 700 the release button 950 can be configured to actuate the system of a collector coupling apparatus 500, 600, 700. Systems and methods of actuating the system of a collector coupling apparatus 500, 600, 700 are well known in the art or will be apparent to one reasonably skilled in the art and any of these systems or methods or variations thereof may be used in other embodiments of the present invention.

In an additional embodiment of the invention, the handle may have one or more handle segment. Systems and methods associated with providing a telescoping handle are well known in the art and one or more of these methods, or variations thereon can be applied or used in further embodiments of the present invention.

In addition to the methods of use already described herein the following are some examples of preferred methods of using the present invention and should not be considered to limit the scope of use of the present invention; other methods of use will be become immediately apparent to a user or those reasonably skilled in the art.

In one embodiment, after a pet defecates, a user can use a scooper head as shown in FIG. 1 or FIG. 2, which is coupled to a collector coupling apparatus that is coupled to a handle, to scoop the pet excrement into the bag. The user can use any edge of the frame to scoop under the pet excrement so as to direct the pet excrement into the bag.

In another embodiment, after a pet defecates, the user can use a scooper head as shown in FIG. 2, which is coupled to a collector coupling apparatus that is coupled to a handle, to scoop the pet excrement into the bag. The user can use any edge of the frame or bag lip to scoop under the pet excrement so as to direct the pet excrement into the bag.

In one embodiment, after a pet defecates, the user can use a scooper head as shown in FIG. 3, which is coupled to a collector coupling apparatus that is coupled to a handle, to scoop the pet excrement into the bag. The user can use any edge of the frame or bag lip to scoop under the pet excrement so as to direct the pet excrement into the bag. The user can then close or partially close the bag into a configuration as shown in FIG. 4.

In another embodiment a user may position a scooper head which is coupled to a collector coupling apparatus that is coupled to a handle beneath a defecating pet such that the pet will defecate into the bag or into the orifice created by the bag.

In another embodiment of the invention, a user may eject or remove the scooper head from the collector coupling apparatus after the bag has been filled or has received with pet excrement and the scooper head can be disposed-of or thrown away.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

What is claimed is:

1. A scooper for collecting pet excrement, comprising:
a handle; and
a collector attached removably to the handle, the collector including a preassembled combination comprising:
a frame, and
a bag having a rim that is coupled to the frame such that the bag is held open by the frame for receiving the pet excrement through the rim.

2. The scooper of claim 1, in which
the frame forms a closed loop.

3. The scooper of claim 1, in which
the frame has a perimeter that is substantially circular.

4. The scooper of claim 1, in which
the frame has a perimeter with at least one straight edge.

5. The scooper of claim 1, in which
the frame includes at least one inflexible member and one flexible member.

6. The scooper of claim 1, in which
a rim of the bag is wrapped around at least a portion of the frame, and glued unto itself.

7. The scooper of claim 1, further comprising:
a collector coupling apparatus attached to the handle, and
in which the collector is attached removably to the collector coupling apparatus.

8. The scooper of claim 7, in which
the collector includes a plug, and
the collector coupling apparatus includes a slot for slidably receiving the plug.

9. The scooper of claim 7, in which
the collector coupling apparatus includes a release mechanism for releasing the collector.

10. The scooper of claim 9, in which
the collector coupling apparatus further includes an ejection mechanism for ejecting the collector when the release mechanism is actuated.

11. A method for collecting pet excrement, comprising:
walking a pet while carrying a scooper that has a handle and a collector attached removably to the handle, the collector including a preassembled combination comprising: a frame, and a bag having a rim that is coupled to the frame such that the bag is held open by the frame for receiving the pet excrement through the rim;
collecting excrement of the pet in the collector; and
then removing the collector from the handle.

12. The method of claim 11, in which
a rim of the bag is wrapped around at least a portion of the frame, and glued unto itself.

13. The method of claim 11, in which
removing is performed such that the collector is received by a trash can.

14. The method of claim 11, in which
removing is performed by shaking.

15. The method of claim 11, in which
removing is performed by pressing a button of a release mechanism.

16. The method of claim 11, in which
removing is performed by pressing actuating a lever of a release mechanism.

17. The method of claim 11, in which
removing results in ejecting the collector.

18. A preassembled collector for a scooper having a handle, comprising:
a frame for being removably attached to the handle, and
a bag having a rim that is coupled to the frame such that the bag is held open by the frame for receiving the pet excrement through the rim.

19. The collector of claim 18, in which
a rim of the bag is wrapped around at least a portion of the frame, and glued unto itself.

20. The collector of claim 18, in which
the frame forms a closed loop.

21. The collector of claim 18, in which
the frame has a perimeter that is substantially circular.

22. The collector of claim 18, in which
the frame has a perimeter with at least one straight edge.

23. The collector of claim 18, in which
the frame includes at least one inflexible member and one flexible member.

24. The collector of claim 18, in which
the scooper includes a collector coupling apparatus attached to the handle, and
the frame is attached removably to the collector coupling apparatus.

25. The collector of claim 24, in which
the frame includes a plug, and
the collector coupling apparatus includes a slot for slidably receiving the plug.
